(19) United States
(12) Patent Application Publication
(10) Pub. No.: US 2013/0309490 A1
(43) Pub. Date: Nov. 21, 2013

(54) CARBON FIBER BRAID

(71) Applicants: Satoshi SEIKE, Decatur, AL (US); Makoto Kibayashi, Decatur, AL (US); Anand Valliyur Rau, Decatur, AL (US)

(72) Inventors: Satoshi SEIKE, Decatur, AL (US); Makoto Kibayashi, Decatur, AL (US); Anand Valliyur Rau, Decatur, AL (US)

(21) Appl. No.: 13/471,957

(22) Filed: May 15, 2012

(51) Int. Cl. D04C 1/04; B32B 9/00

(52) U.S. Cl. 428/364

(57) ABSTRACT

A carbon fiber braid is made of a carbon fiber, which is coated with a sizing being formed of a heat resistant polymer or a precursor of the heat resistant polymer.

### BACKGROUND OF THE INVENTION AND RELATED ART STATEMENT

The present invention relates to a carbon fiber braid with a sizing capable of achieving good mechanical property and high resistance against thermal degradation.

Carbon Fiber Reinforced Plastics (CFRP) have superior mechanical properties such as high specific strength and high specific modulus; therefore, they are widely used for a wide variety of applications, e.g., aerospace, sports equipment, industrial goods, and the like. In particular, CFRP with a matrix consisting of a thermoplastic resin has a great advantage such as quick molding and superior impact strength. In recent years, research and development efforts in this area have been flourishing.

In general, polymer matrix composite materials tend to show reduced strength and modulus under high temperature conditions. Therefore, heat resistant matrix resins are necessary in order to maintain desired mechanical properties under high temperature conditions. Such heat resistant matrix resins include a thermosetting polyimide resin, a urea formaldehyde resin, a thermoplastic polyimide resin, a polyamideimide resin, a polyetherimide resin, a polysulfone resin, a polyethersulfone resin, a polyetheretherketone resin, a polyetherketoneketone resin, a polyamide, and a polyphenylenesulfide resin.

CFRP with heat resistant matrix resins are molded under high temperature conditions, so a sizing must withstand thermal degradation. If the sizing undergoes thermal degradation, voids and some other problems occur inside a composite, resulting in undesired composite mechanical properties. Accordingly, a heat resistant sizing is an essential part of CFRP for better handleability, superior interfacial adhesive capability, controlling fuzz development, etc.

In U.S. Pat. No. 5,619,903, carbon fiber braid having longitudinal axis and a plurality of braided axial and oblique strands has been disclosed. In U.S. Pat. No. 5,468,327, an apparatus and method for forming a braid reinforced thermoplastic member have been disclosed. However, a sizing and a sized fiber used for heat resistant applications have not been described.

An object of the present invention is to provide a carbon fiber braid containing a carbon fiber with a thermally stable sizing that enables enhanced adhesion to the thermoplastic matrix, good resin impregnation, and a lower propensity for generation of voids and harmful volatiles during processing owing to the inherent thermal stability as compared with less stable sizings.

Further objects and advantages of the invention will be apparent from the following description of the invention.

### SUMMARY OF THE INVENTION

In order to attain the objects described above, according to the present invention, carbon fiber braid is made of a carbon fiber coated with a sizing being formed of a heat resistant polymer or a precursor of the heat resistant polymer.

### BRIEF DESCRIPTION OF THE DRAWINGS

FIG. 1 is a graph showing a relationship between strand tensile strength and sizing amount (KAPTON type polyimide, T800SC-24K, KAPTON is a registered trademark of E. I. du Pont de Nemours and Company);

FIG. 2 is a graph showing a relationship between drape value and sizing amount (KAPTON type polyimide, T800SC-24K)

FIG. 3 is a graph showing a relationship between rubbing fuzz and sizing amount (KAPTON type polyimide, T800SC-24K);

FIG. 4 is a graph showing a relationship between ILSS and sizing amount (KAPTON type polyimide, T800SC-24K);

FIG. 5 is a graph showing a TGA measurement result of T800S type fiber coated with KAPTON type polyimide;

FIG. 6 is a graph showing a TGA measurement result of KAPTON type polyimide;

FIG. 7 is a graph showing a relationship between strand tensile strength and sizing amount (ULTEM type polyetherimide, T800SC-24K, ULTEM is a registered trademark of Saudi Basic Industries Corporation);

FIG. 8 is a graph showing a relationship between drape value and sizing amount (ULTEM type polyetherimide, T800SC-24K);

FIG. 9 is a graph showing a relationship between rubbing fuzz and sizing amount (ULTEM type polyetherimide, T800SC-24K);

FIG. 10 is a graph showing a relationship between ILSS and sizing amount (ULTEM type polyetherimide, T800SC-24K);

FIG. 11 is a graph showing a TGA measurement result of T800S type fiber coated with ULTEM type polyetherimide;

FIG. 12 is a graph showing a TGA measurement result of ULTEM type polyetherimide;

FIG. 13 is a graph showing a relationship between strand tensile strength and sizing amount (ULTEM type polyetherimide, T700SC-12K);

FIG. 14 is a graph showing a relationship between drape value and sizing amount (ULTEM type polyetherimide, T700SC-12K);

FIG. 15 is a graph showing a relationship between rubbing fuzz and sizing amount (ULTEM type polyetherimide, T700SC-12K);

FIG. 16 is a graph showing a relationship between ILSS and sizing amount (ULTEM type polyetherimide, T700SC-12K);

FIG. 17 is a graph showing a relationship between strand tensile strength and sizing amount (Methylated melamine-formaldehyde, T700SC-12K);

FIG. 18 is a graph showing a relationship between drape value and sizing amount (Methylated melamine-formaldehyde, T700SC-12K);

FIG. 19 is a graph showing a relationship between rubbing fuzz and sizing amount (Methylated melamine-formaldehyde, T700SC-12K);

FIG. 20 is a graph showing a relationship between ILSS and sizing amount (Methylated melamine-formaldehyde, T700SC-12K);

FIG. 21 is a graph showing a TGA measurement result of T700S type fiber coated with methylated melamine-formaldehyde;

FIG. 22 is a graph showing a TGA measurement result of methylated melamine-formaldehyde;

FIG. 23 is a graph showing a relationship between strand tensile strength and sizing amount (Epoxy cresol novolac, T700SC-12K);

FIG. 24 is a graph showing a relationship between drape value and sizing amount (Epoxy cresol novolac, T700SC-12K);

FIG. 25 is a graph showing a relationship between rubbing fuzz and sizing amount (Epoxy cresol novolac, T700SC-12K);

FIG. 26 is a graph showing a relationship between ILSS and sizing amount (Epoxy cresol novolac, T700SC-12K);

FIG. 27 is a graph showing a TGA measurement result of T700S type fiber coated with epoxy cresol novolac;

FIG. 28 is a graph showing a TGA measurement result of epoxy cresol novolac;

FIG. 29 is a schematic view showing a measurement procedure of drape value;

FIG. 30 is a schematic view showing a measurement instrument of rubbing fuzz;

FIG. 31 is geometry of a dumbbell shaped specimen for Single Fiber Fragmentation Test;

Table 1 shows a relationship between strand tensile strength and sizing amount (KAPTON type polyimide, T800SC-24K);

Table 2 shows a relationship between drape value and sizing amount (KAPTON type polyimide, T800SC-24K);

Table 3 shows a relationship between rubbing fuzz and sizing amount (KAPTON type polyimide, T800SC-24K);

Table 4 shows a relationship between ILSS and sizing amount (KAPTON type polyimide, T800SC-24K);

Table 5 shows a relationship between strand tensile strength and sizing amount (ULTEM type polyetherimide, T800SC-24K);

Table 6 shows a relationship between drape value and sizing amount (ULTEM type polyetherimide, T800SC-24K);

Table 7 shows a relationship between rubbing fuzz and sizing amount (ULTEM type polyetherimide, T800SC-24K);

Table 8 shows a relationship between ILSS and sizing amount (ULTEM type polyetherimide, T800SC-24K);

Table 9 shows a relationship between strand tensile strength and sizing amount (ULTEM type polyetherimide, T700SC-12K);

Table 10 shows a relationship between drape value and sizing amount (ULTEM type polyetherimide, T700SC-12K);

Table 11 shows a relationship between rubbing fuzz and sizing amount (ULTEM type polyetherimide, T700SC-12K);

Table 12 shows a relationship between ILSS and sizing amount (ULTEM type polyetherimide, T700SC-12K);

Table 13 shows a relationship between strand tensile strength and sizing amount (Methylated melamine-formaldehyde, T700SC-12K);

Table 14 shows a relationship between drape value and sizing amount (Methylated melamine-formaldehyde, T700SC-12K);

Table 15 shows a relationship between rubbing fuzz and sizing amount (Methylated melamine-formaldehyde, T700SC-12K);

Table 16 shows a relationship between ILSS and sizing amount (Methylated melamine-formaldehyde, T700SC-12K);

Table 17 shows a relationship between strand tensile strength and sizing amount (Epoxy cresol novolac, T700SC-12K);

Table 18 shows a relationship between drape value and sizing amount (Epoxy cresol novolac, T700SC-12K);

Table 19 shows a relationship between rubbing fuzz and sizing amount (Epoxy cresol novolac, T700SC-12K);

Table 20 shows a relationship between ILSS and sizing amount (Epoxy cresol novolac, T700SC-12K);

Table 21 shows adhesion strength between a T800S type fiber and polyetherimide resin; and

Table 22 shows adhesion strength between a T700S type fiber and polyetherimide resin.

### DETAILED DESCRIPTION OF PREFERRED EMBODIMENTS

Embodiments of the present invention will be explained with reference to the accompanying drawings.

In the embodiment, a carbon fiber braid of this invention can be a complex structure or pattern such as bifurcation, trifurcation, two or three-dimensional shape formed by intertwining three or more strands of flexible material to provide seamless fiber continuity throughout the part and mechanically interlocked fiber product.

The carbon fiber braid is made of commercially available carbon fiber (including graphite fiber). Specifically, a pitch type carbon fiber, a rayon type carbon fiber, or a PAN (polyacrylonitrile) type carbon fiber is used. Among these carbon fibers, the PAN type carbon fibers that have high tensile strength are the most desirable for the invention.

Among the carbon fibers, there are a twisted carbon fiber, an untwisted carbon fiber and a never twisted carbon fiber. The carbon fibers have preferably a yield of 0.06 to 4.0 g/m and a filament number of 1,000 to 48,000. In order to have high tensile strength and high tensile modulus in addition to low fuzz generation during the carbon fiber production, the single filament diameter should be within 3 μm to 20 μm, more ideally, 4 μm to 10 μm.

Strand strength is desirably 3.0 GPa or above. 4.5 GPa or above is more desirable. 5.5 GPa or above is even more desirable. Tensile modulus is desirably 200 GPa or above. 220 GPa or above is more desirable. 240 GPa or above is even more desirable. If the strand strength and modulus of the carbon fiber are below 3.0 GPa and 200 GPa, respectively, it is difficult to obtain the desirable mechanical property when the carbon fiber is made into composite materials.

The desirable sizing amount on carbon fiber is 0.05 weight % or above. 0.1 weight % or above is more desirable. And 2.0 weight % or below is desirable. 1.0 weight % or below is more desirable. 0.7 weight % or below is more desirable. 0.3 weight % or below is even more desirable. If the sizing amount is less than 0.05 weight %, when carbon fiber is produced, fuzz generation makes the smooth production more difficult. On the other hand, if much sizing is coated on a carbon fiber, the carbon fiber is almost completely coated by the heat resistant polymer, resulting in low density of a carbon fiber strand, and poor spreadability. When this occurs, even resins with relatively low viscosity have undergone reduced impregnation; thereby leading to low mechanical properties. In addition from an environmental standpoint, the possibility that harmful volatiles are generated becomes higher during the sizing application process.

This invention is not limited to any particular method for manufacturing the braid. Conventional methods can be used.

The desirable relation B/A is greater than 1.05, and more desirable relation B/A is greater than 1.1, where A is the Interfacial Shear Strength (IFSS) of unsized fiber and B is IFSS of sized fiber in the present invention whose surface treatment must be same as the unsized fiber. IFSS can be measured by the Single Fiber Fragmentation Test (SFFT), and unsized fiber could be de-sized fiber. A SFFT procedure and a de-sizing method will be described later.

Carbonization, carbon fiber surface treatment, sizing application and winding are preferably in continuous process. Sizing application process as a part of carbon fiber manufacturing is preferable. Post application or “oversizing” of carbon fiber can be also used.

In order for the carbon fiber braid to have superior resin impregnation, a drape value (measured by the procedures described below) of the fiber should be less than 15 cm, 12 cm or less is better, 10 cm or less is even more desirable, 8 cm or less is most desirable.

As to the matrix resin, either thermosetting or thermoplastic resins could be used. As for the thermosetting resins, the invention is not limited to any particular resins, and a thermosetting polyimide resin, an epoxy resin, a polyester resin, a polyurethane resin, a urea resin, a phenol resin, a melamine resin, a cyanate ester resin, and a bismaleimide resin may be used. As for the thermoplastic resin, resins, mostly heat resistant resins, that contain oligomer could be used. The invention is not limited to any particular heat resistant thermoplastic resins, and a thermoplastic polyimide resin, a polyamideimide resin, a polyetherimide resin, a polysulfone resin, a polyethersulfone resin, a polyetheretherketone resin, a polyetherketoneketone resin, a polyamide, and a polyphenylenesulfide resin may be used.

A heat resistant polymer is a desirable sizing agent to be used for coating a carbon fiber. The sizing agents are preferably a phenol resin, a urea resin, a melamine resin, a polyimide resin, a polyetherimide resin, or others, which can be an aqueous solution, an aqueous dispersion or an aqueous emulsion. These polymers can be also dissolved with organic solvent and applied to a carbon fiber. And organic solvent based sizing agents such as a polysulfone resin, a polyethersulfone resin, a polyetheretherketone resin, a polyetherketoneketone resin, a polyphenylenesulfide resin, a polyamide resin, or others can be also used. For some types of sizings, when the heat resistant polymer or polymer precursor is reacted chemically in order to obtain heat resistant polymer coating on a carbon fiber, water could be generated as a condensation product. For these sizings, it is desirable to complete the reaction in the process of the sizing application as much as possible. Otherwise, voids in a composite could become a problem due to water generation. An example of a heat resistant polymer will be shown as below.

A polyimide is made by heat reaction or chemical reaction of polyamic acid. During the imidization process, water is generated; therefore, it is important to complete imidization before composite fabrication. A water generation ratio W based on a carbon fiber during a composite fabrication process is preferably 0.05 weight % or less. 0.03 weight % or less is desirable. Ideally, 0.01 weight % or less is optimal. The water generation ratio W can be defined by the following equation:

W(weight %)=B/A×100

where the weight A of a sized fiber is measured after holding 2 hours at 110 degrees Celsius and the weight difference B between 130 degrees Celsius and 415 degrees Celsius of a sized fiber is measured under air atmosphere with TGA (holding 110 degrees Celsius for 2 hours, then heating up to 450 degrees Celsius at 10 degrees Celsius/min).

An imidization ratio X of 80% or higher is acceptable, and 90% or higher is desirable. Ideally, 95% or higher is optimal. The imidization ratio X is defined by the following equation:

X(%)=(1−D/C)×100

where the weight loss ratio C of a polyamic acid without being imidized and the weight loss ratio D of a polyimide are measured between 130 degrees Celsius and 415 degrees Celsius under air atmosphere with TGA (holding 110 degrees Celsius for 2 hours, then heating up to 450 degrees Celsius at 10 degrees Celsius/minute).

The heat resistant polymer is preferably used in a form of an organic solvent solution, an aqueous solution, an aqueous dispersion or an aqueous emulsion of the polymer itself or a polymer precursor. A polyamic acid which is the precursor to a polyimide is enabled to be water soluble by neutralization with alkali. It is preferred for the alkali to be water soluble. Chemicals such as ammonia, a monoalkyl amine, a dialkyl amine, a trialkyl amine, and tetraalkylammonium hydroxide could be used.

Organic solvents such as DMF (dimethylformamide), DMAc (dimethylacetamide), DMSO (dimethylsulfoxide), NMP (N-methylpyrrolidone), THF (tetrahydrofuran), etc. could be used. Naturally, low boiling point and safe solvents should be selected. It is desirable that the sizing agent is dried and sometimes reacted chemically in low oxygen concentration air or inert atmosphere such as nitrogen to avoid forming explosive mixed gas.

### <Glass Transition Temperature>

The sizing has a glass transition temperature above 100 degrees Celsius. Above 150 degrees Celsius is better. Even more preferably the glass transition temperature shall be above 200 degrees Celsius.

A glass transition temperature is measured according to ASTM E1640 Standard Test Method for “Assignment of the Glass Transition Temperature by Dynamic Mechanical Analysis” using a Differential Scanning calorimetry (DSC).

### <Thermal Degradation Onset Temperature>

A thermal degradation onset temperature of a sized fiber is preferably above 300 degrees Celsius. 370 degrees Celsius or higher is more desirable, 450 degrees Celsius or higher is more desirable, and 500 degrees Celsius or higher is most desirable. When a thermal degradation onset temperature is measured, first, a sample with a weight of about 5 mg is dried in an oven at 110 degrees Celsius for 2 hours, and cooled down to room temperature. Then it is weighed and placed on a thermogravimetric analyzer (TGA) under air atmosphere. Then, the sample is analyzed under an air flow of 60 ml/minute at a heating ratio of 10 degrees Celsius/minute. A weight change is measured between room temperature and 600 degrees Celsius. The degradation onset temperature of a sized fiber is defined as a temperature at which an onset of a major weight loss occurs. From the TGA experimental data, the sample weight, expressed as a percentage of the initial weight, is plotted as a function of the temperature (abscissa). By drawing tangents on a curve, the thermal degradation onset temperature is defined as an intersection point where tangent at a steepest weight loss crosses a tangent at minimum gradient weight loss adjacent to the steepest weight loss on a lower temperature side.

The definition of a thermal degradation onset temperature applies to the state of a carbon fiber after the chemical reaction but before a resin impregnation. The heat resistant property is imparted to the sized fiber by a chemical reaction affected before fiber is impregnated with resin.

If it is difficult to measure a thermal degradation onset temperature of a sized fiber, the sizing can be used in place of a sized fiber.

### <30% Weight Reduction Temperature>

A 30% weight reduction temperature of a sizing is preferably higher than 350 degrees Celsius. 420 degrees Celsius or higher is more desirable. 500 degrees Celsius or higher is most desirable. When a 30% weight reduction temperature is measured, first, a sample with a weight of about 5 mg is dried in an oven at 110 degrees Celsius for 2 hours, and cooled down to room temperature. Then it is weighed and placed on a thermogravimetric analyzer (TGA) under air atmosphere. Then, the sample is analyzed under an air flow of 60 ml/minute at a heating ratio of 10 degrees Celsius/minute. A weight change is measured between room temperature and 650 degrees Celsius. From the TGA experimental data, the sample weight, expressed as a percentage of the initial weight, is plotted as a function of the temperature (abscissa). The 30% weight reduction temperature of the sizing is defined as a temperature at which the weight of the sizing reduces by 30% with reference to the weight of the said sizing at 130 degrees Celsius.

### <Sizing Agent Application Method>

A sizing agent application method includes a roller sizing method, a submerged roller sizing method and/or a spray sizing method. The submerged roller sizing method is desirable because it is possible to apply a sizing agent very evenly even to large filament count tow fibers. Sufficiently spread carbon fibers are submerged in the sizing agent. In this process, a number of factors become important such as a sizing agent concentration, temperature, fiber tension, etc. for the carbon fiber to attain the optimal sizing amount for the ultimate objective to be realized. Often, ultrasonic agitation is applied to vibrate carbon fiber during the sizing process for better end results.

### <Drying Treatment>

After the sizing application process, the carbon fiber goes through the drying treatment process in which water and/or organic solvent will be dried, which are solvent or dispersion media. Normally an air dryer is used and the dryer is run for 6 seconds to 15 minutes. The dry temperature should be set at 200 degrees Celsius to 450 degrees Celsius, 240 degrees Celsius to 410 degrees Celsius would be more ideal, 260 degrees Celsius to 370 degrees Celsius would be even more ideal, and 280 degrees Celsius to 330 degrees Celsius would be most desirable.

In case of thermoplastic dispersion, it is desirable that it should be dried at over the formed or softened temperature. This could also serve a purpose of reacting to the desired polymer characteristics. For this invention, the heat treatment will possibly be used with a higher temperature than the temperature used for the drying treatment. The atmosphere to be used for the drying treatment should be air; however, when an organic solvent is used in the process, an inert atmosphere involving elements such as nitrogen could be used.

### <Winding Process>

The carbon fiber tow, then, is wound onto a bobbin. The carbon fiber produced as described above is evenly sized. This helps make desired carbon fiber reinforced composites materials when mixed with the resin.

### EXAMPLES

Examples of the carbon fiber will be explained next. The following methods are used for evaluating properties of the carbon fiber.

### <Sizing Amount>

Sizing amount in this invention is defined as the higher of the values obtained by the following two methods outlined below, and is considered to represent a reasonably true estimate of the actual amount of sizing on the fiber.

### (Alkaline Method)

Sizing amount (weight %) is measured by the following method.

(1) About 5 g carbon fiber is taken.
(2) The sample is placed in an oven at 110 degrees Celsius for 1 hour.
(3) It is then placed in a desiccator to be cooled down to the ambient temperature (room temperature).
(4) A weight W₀ is weighed.
(5) For removing the sizing by alkaline degradation, it is put in 5% KOH solution at 80 degrees Celsius for 4 hours.
(6) The de-sized sample is rinsed with enough water and placed in an oven for 1 hour at 110 degrees Celsius.
(7) It is placed in a desiccator to be cooled down to ambient temperature (room temperature).
(8) A weight W₁ is weighed.

The sizing amount (weight %) is calculated by the following formula.

Sizing amount(weight %)=(W₀−W₁)/(W₀)×100

### (Burn Off Method)

The sizing amount (weight %) is measured by the following method.

(1) About 2 g carbon fiber is taken.
(2) The sample is placed in an oven at 110 degrees Celsius for 1 hour.
(3) It is then placed in a desiccator to be cooled down to ambient temperature (room temperature).
(4) A weight W₀ is weighed.
(5) For removing the sizing, it is placed in a furnace of nitrogen atmosphere at 450 degrees Celsius for 20 minutes, where the oxygen concentration is less than 7 weight %.
(6) The de-sized sample is placed in a nitrogen purged container for 1 hour.
(7) A weight W₁ is weighed.
The sizing amount (weight %) is calculated by the following formula.

Sizing amount(weight %)=(W₀−W₁)/(Wₒ)×100

### <Strand Tensile Strength>

Tensile strength of the strand specimen made of polymer coated carbon fiber and epoxy resin matrix is measured according to ASTM D4018 Standard Test Method for “Properties of Continuous Filament Carbon and Graphite Fiber Tows”.

### <Drape Value>

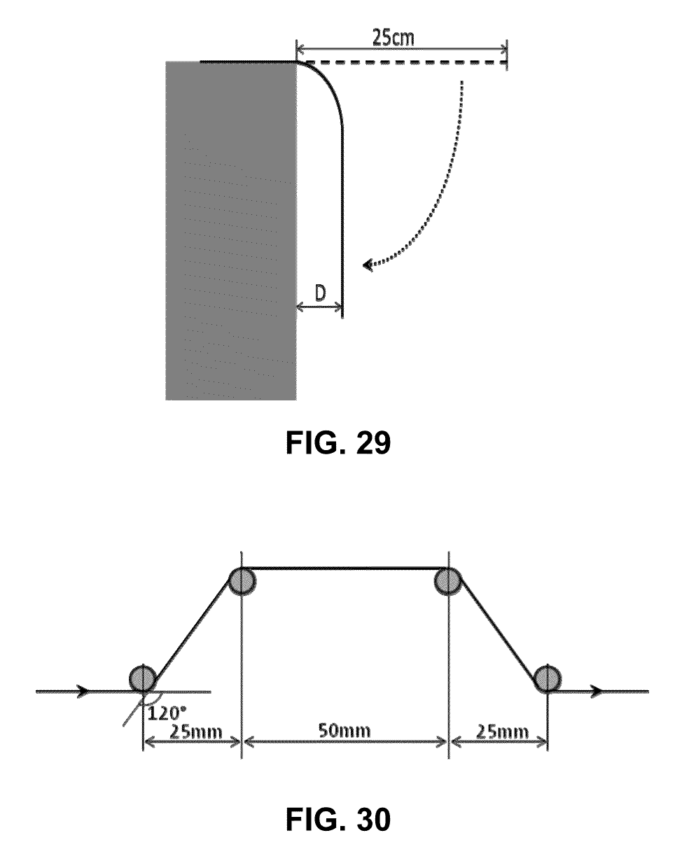

A carbon fiber tow is cut from the bobbin to a length of about 50 cm without applying any tension. A weight is attached on one end of the specimen after removing any twists and/or bends. The weight is 30 g for 12,000 filaments and 60 g for 24,000 filaments, so that 1 g tension is applied per 400 filaments. The specimen is then hung in a vertical position for 30 minutes with the weighted end hanging freely. After the weight is released from the specimen, the specimen is placed on a rectangular table such that a portion of the specimen is extended by 25 cm from an edge of the table having 90 degrees angle as shown in FIG. 29. The specimen on the table is fixed with an adhesive tape without breaking so that the portion hangs down from the edge of the table. A distance D (refer to FIG. 29) between a tip of the specimen and a side of the table is defined as the drape value.

### <Rubbing Fuzz Count>

As shown in FIG. 30, a carbon fiber tow is slid against four pins with a diameter of 10 mm (material: chromium steel, surface roughness: 1 to 1.5 μm RMS) at a speed of 3 meter/minute in order to generate fuzz. The initial tension to a carbon fiber is 500 g for the 12,000 filament strand and 650 g for 24,000 filament strand. The carbon fiber is slid against the pins by an angle of 120 degrees. The four pins are placed (horizontal distance) 25 mm, 50 mm and 25 mm apart (refer to FIG. 30). After the carbon fiber passes through the pins, fuzz blocks light incident on a photo electric tube from above, so that a fuzz counter counts the fuzz count.

### <Interlaminar Shear Strength (ILSS)>

ILSS of the composites consisting of the polymer coated carbon fiber and an epoxy resin matrix is measured according to ASTM D2344 Standard Test Method for “Short-Beam Strength of Polymer Matrix Composite Materials and Their Laminates”.

### <Single Fiber Fragmentation Test (SFFT)>

Specimens are prepared with the following procedure.

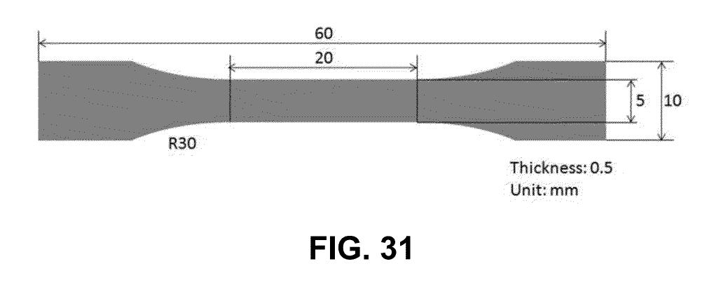

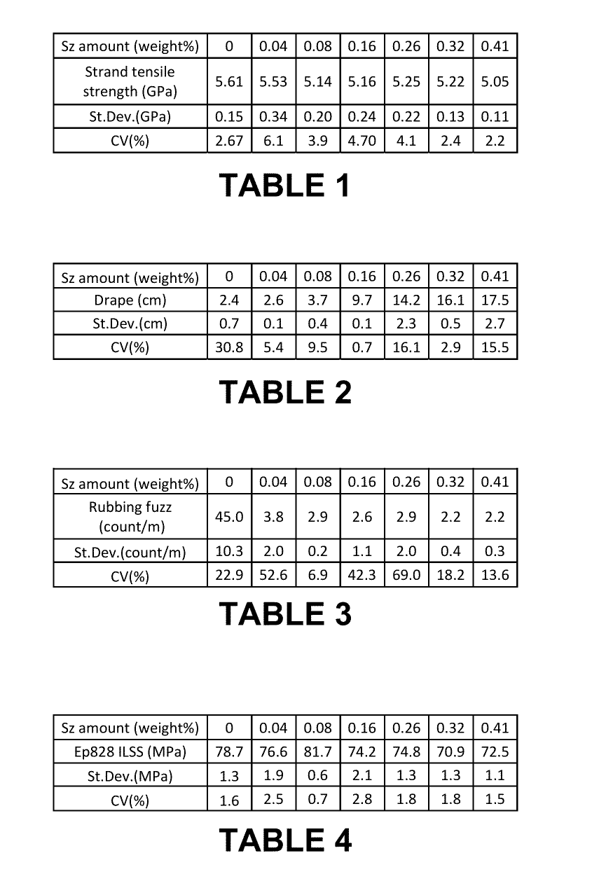

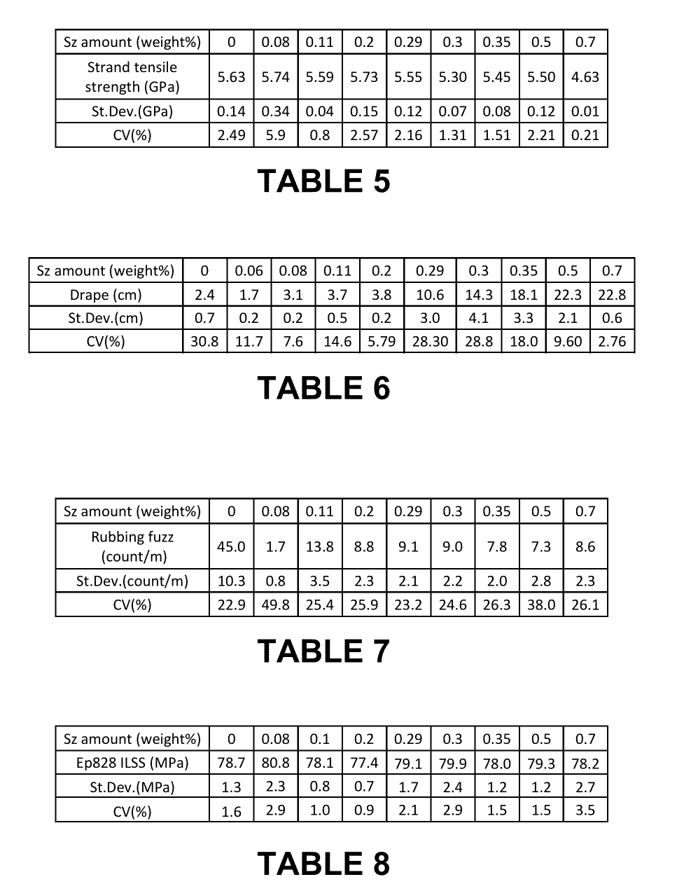

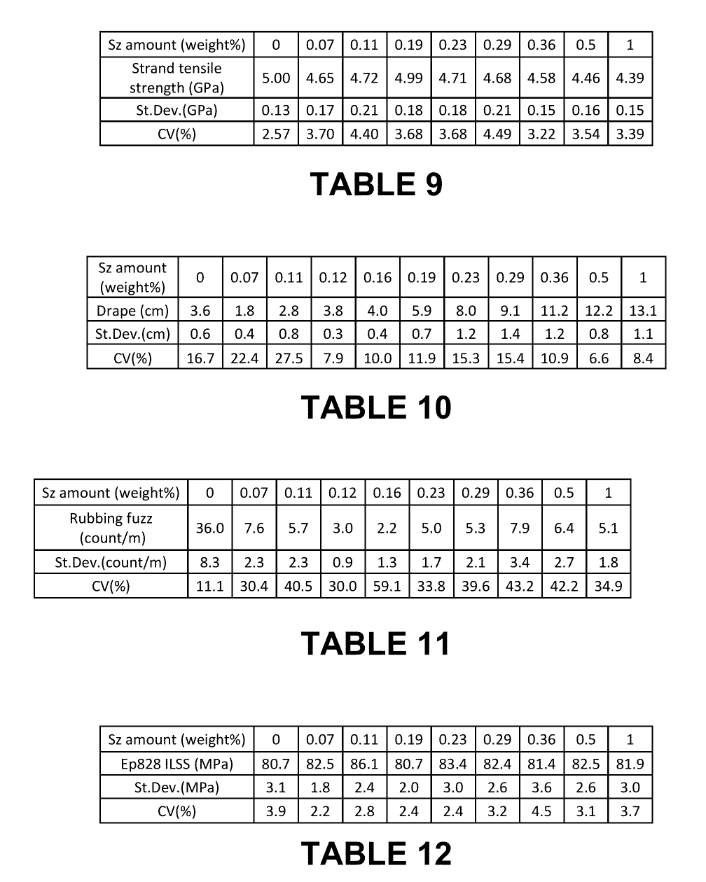

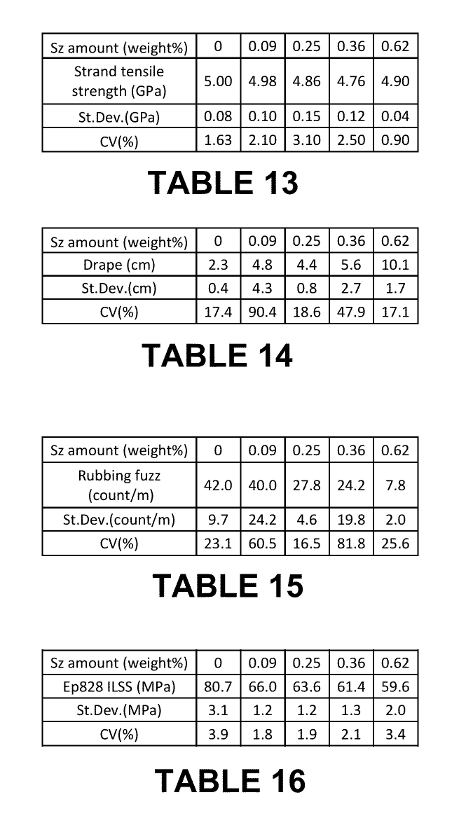

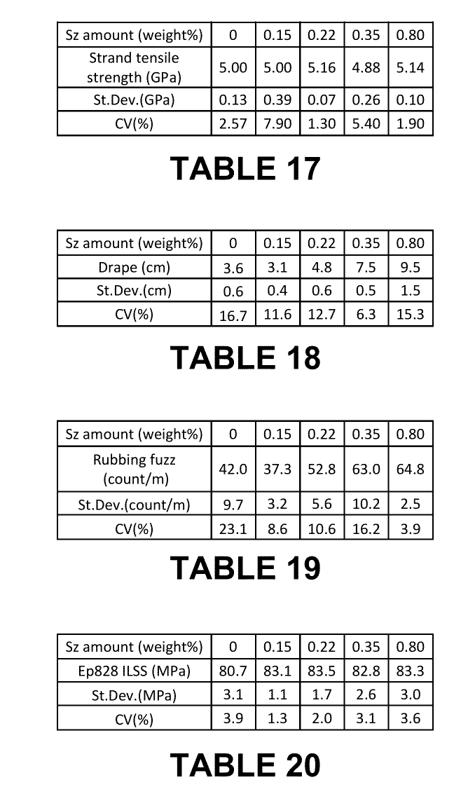

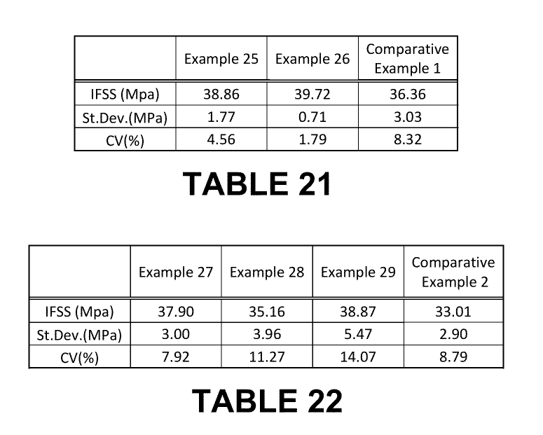

(1) Two aluminum plates (length: 250×width: 250×thickness: 6 (mm)), a KAPTON film (thickness: 0.1 (mm)), a KAPTON tape, a mold release agent, an ULTEM type polyetherimide resin sheet (thickness 0.26 (mm)), which must be dried in a vacuum oven at 110 degrees Celsius for at least 1 day, and carbon fiber strand are prepared.
(2) The KAPTON film (thickness: 0.1 (mm)) coated with a mold release agent is set on an aluminum plate.
(3) The ULTEM type polyetherimide resin sheet (length: 90×width: 150×thickness: 0.26 (mm)), whose grease on the surface is removed with acetone, is set on the KAPTON film.
(4) A single filament is picked up from the carbon fiber strand and set on the ULTEM type polyetherimide resin sheet.
(5) The filament is fixed at the both sides with a KAPTON tape to be kept straight.
(6) The filament (filaments) is overlapped with another ULTEM type polyetherimide resin sheet (length: 90×width: 150×thickness: 0.26 (mm)), and KAPTON film (thickness: 0.1 (mm)) coated with a mold release agent is overlapped on it.
(7) Spacers (thickness: 0.7 (mm)) are set between two aluminum plates.
(8) The aluminum plates including a sample are set on the pressing machine at 290 degrees Celsius.
(9) They are heated for 10 minutes contacting with the pressing machine at 0.1 MPa.
(10) They are pressed at 1 MPa and cooled at a speed of 15 degrees Celsius/minute being pressed at 1 MPa.
(11) They are taken out of the pressing machine when the temperature is below 180 degrees Celsius.
(12) A dumbbell shaped specimen, where a single filament is embedded in the center along the loading direction, has the center length 20 mm, the center width 5 mm and the thickness 0.5 mm as shown in FIG. 31.

SFFT is performed at an instantaneous strain rate of approximately 4%/minute counting the fragmented fiber number in the center 20 mm of the specimen at every 0.64% strain with a polarized microscope until the saturation of fragmented fiber number. The preferable number of specimens is more than 2 and Interfacial Shear Strength (IFSS) is obtained from the average length of the fragmented fibers at the saturation point of fragmented fiber number.

IFSS can be calculated from the equation below, where σ_{f} is the strand strength, d is the fiber diameter, L_{c} is the critical length (=4*L_{b}/3) and L_{b} is the average length of fragmented fibers.

$$I F S S = \frac{{σ}_{f} \cdot d}{2 {L}_{c}}$$

### <De-Sizing Process>

De-sized fiber may be used for SFFT in place of unsized fiber. De-sizing process is as follows.

(1) Sized fiber is placed in a furnace of nitrogen atmosphere at 500 degrees Celsius, where the oxygen concentration is less than 7 weight %.
(2) The fiber is kept in the furnace for 20 minutes.
(3) The de-sized fiber is cooled down to room temperature in nitrogen atmosphere for 1 hour.

### Examples 1-5

### Comparative Example 1

KAPTON type polyimide coated carbon fiber braid can be obtained by braiding the following carbon fiber. Unsized 24K high tensile strength, intermediate modulus carbon fiber “Torayca” T800SC (Registered trademark by Toray Industries; strand strength 5.9 GPa, strand modulus 294 GPa) was used. The carbon fiber was continuously submerged in the sizing bath containing polyamic acid ammonium salt of 0.1 to 1.0 weight %. The polyamic acid is formed from the monomers pyromellitic dianyhydride and 4,4′-oxydiphenylene. After the submerging process, it was dried at 300 degrees Celsius for 1 minute in order to have poly(4,4′-oxydiphenylene-pyromellitimide) (KAPTON type polyimide) coating. The sizing amount was measured with an alkaline method.

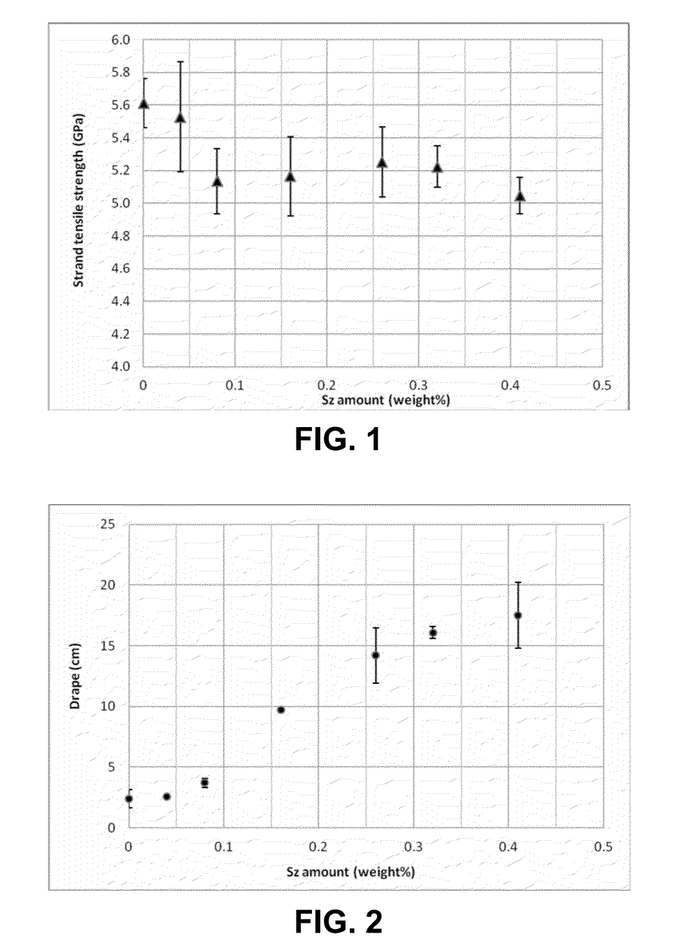

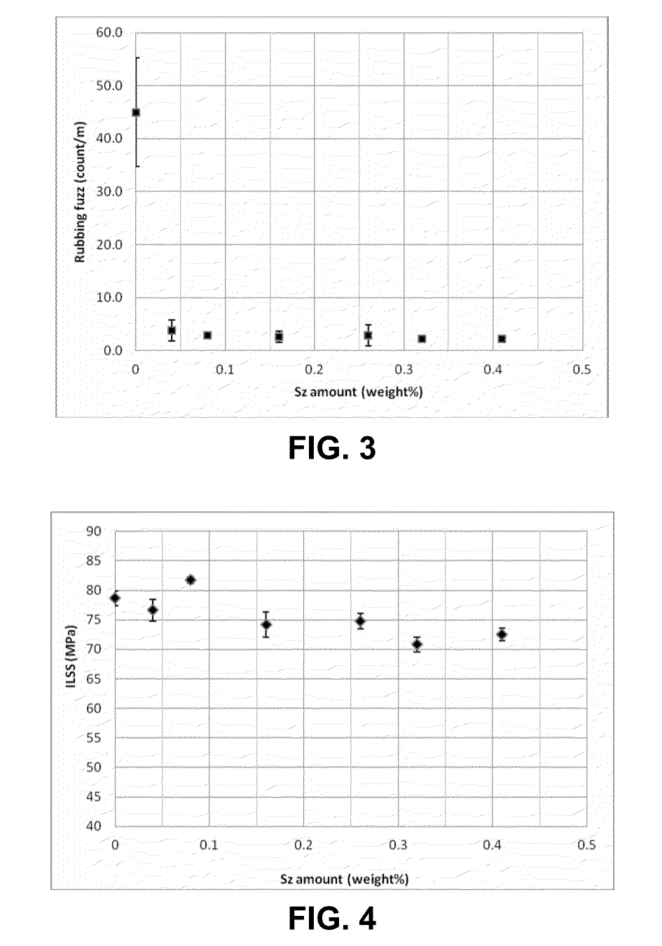

The tensile strengths, drape value, rubbing fuzz and ILSS of both the sizing amount of 0.05 to 0.41 weight % (Example 1-4) and unsized fiber (Comparative Example 1) were measured. The results are shown in Tables 1-4 and FIGS. 1-4. The error bar in the figures indicates the standard deviation.

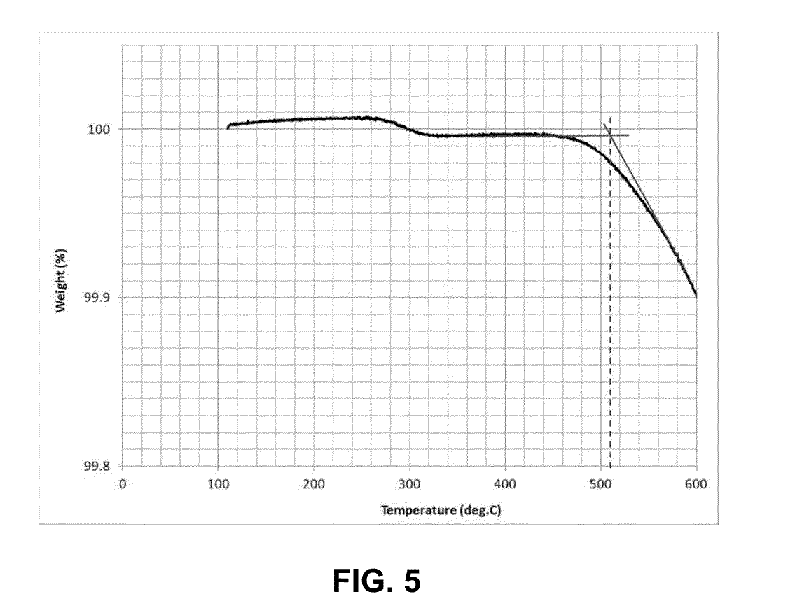

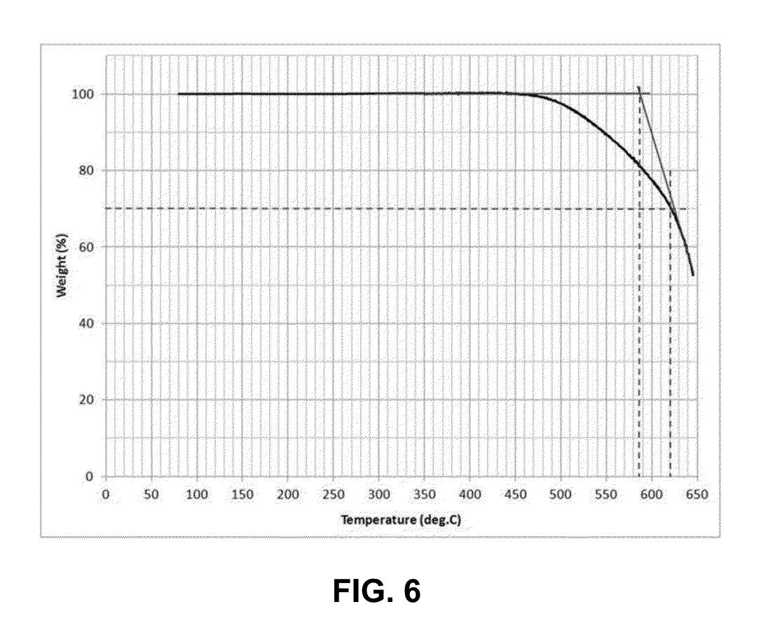

Thermogravimetric analysis (TGA) was conducted under air atmosphere. (Example 5) The heat degradation onset temperature of the same carbon fiber as the above is 510 degrees Celsius as shown in FIG. 5. The heat degradation onset temperature of the sizing of the sizing is 585 degrees Celsius and the 30% weight reduction temperature is 620 degrees Celsius as shown in FIG. 6, confirming the heat resistance is in excess of 500 degrees Celsius.

### Examples 6-10

### Comparative Example 2

ULTEM type polyetherimide coated carbon fiber braid can obtained by braiding the following carbon fiber. Unsized 24K high tensile strength, intermediate modulus carbon fiber “Torayca” T800SC (Registered trademark by Toray Industries; strand strength 5.9 GPa, strand modulus 294 GPa) was used. The carbon fiber was continuously submerged in the sizing bath containing polyamic acid dimethylaminoethanol salt of 0.1 to 2.0 weight %. The polyamic acid is formed from the monomers 2,2′-Bis(4-(3,4-dicarboxyphenol)phenyl)propane dianhydride and meta-phenylene diamine. After the submerging process, it was dried at 300 degrees Celsius for 1 minute in order to have 2,2-Bis(4-(3,4-dicarboxyphenol)phenyl)propane dianhydride-m-phenylene diamine copolymer (ULTEM type polyetherimide) coating. The imidization ratio was 98%. The sizing amount was measured with an alkaline method.

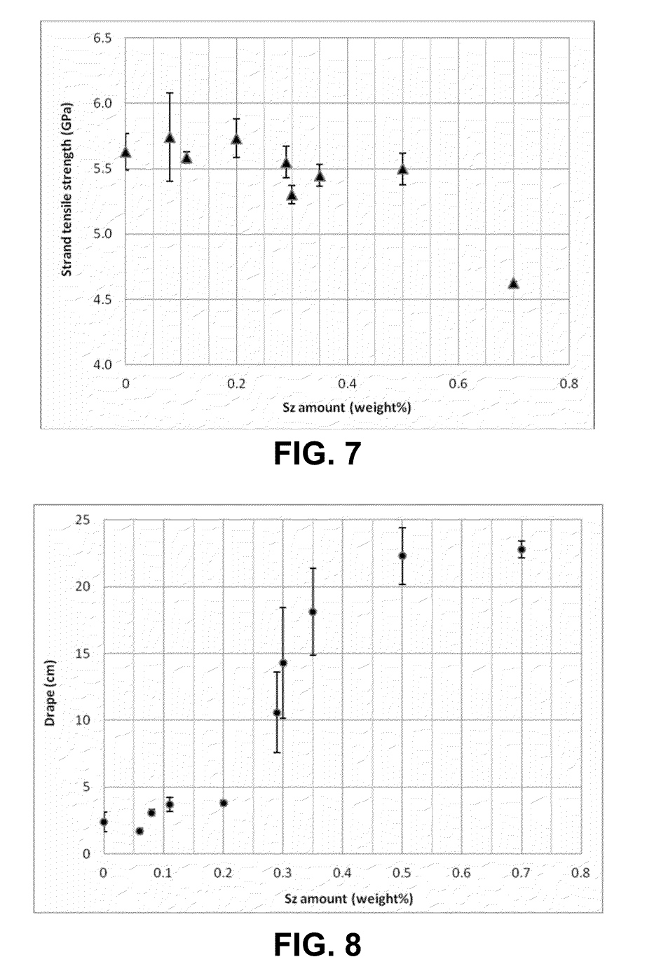

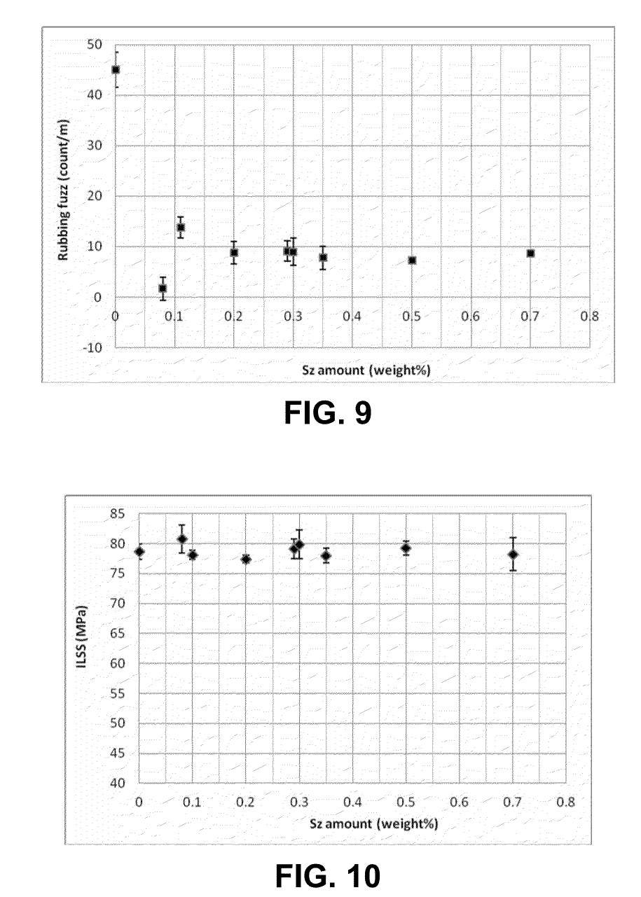

The tensile strengths, drape value, rubbing fuzz and ILSS of both the sizing amount of 0.05 to 0.70 weight % (Examples 6-9) and unsized fiber (Comparative Example 2) were measured. The results are shown in Tables 5-8 and FIGS. 7-10. The error bar in the figures indicates the standard deviation.

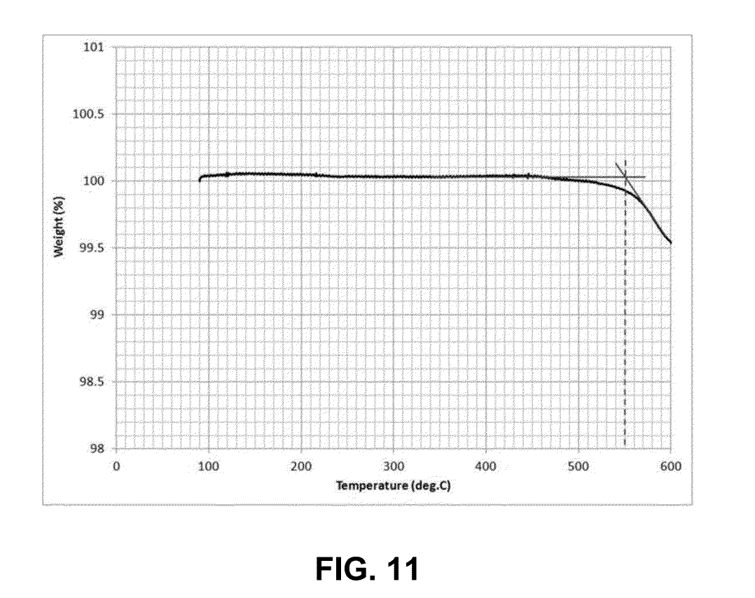

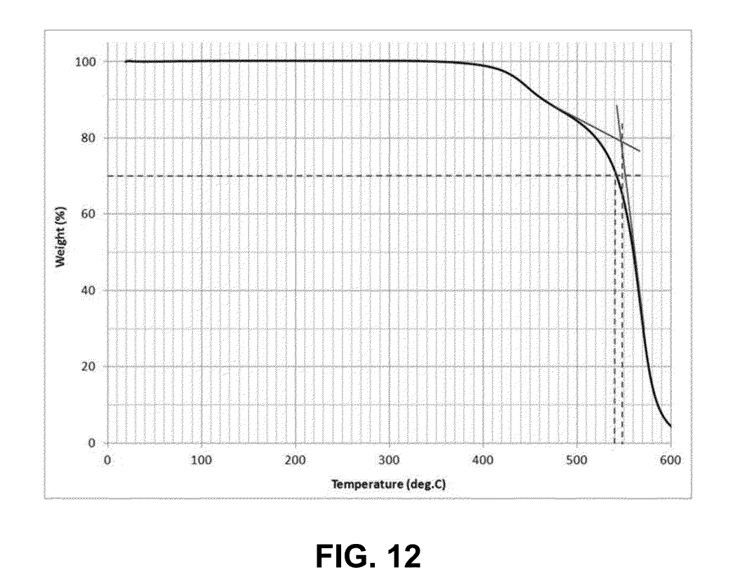

Thermogravimetric analysis (TGA) was conducted under air atmosphere. (Example 10) The heat degradation onset temperature of the same carbon fiber as the above is over 550 degrees Celsius as shown in FIG. 11. The heat degradation onset temperature of the sizing was 548 degrees Celsius and the 30% weight reduction temperature is 540 degrees Celsius as shown in FIG. 12, confirming the heat resistance is in excess of 500 degrees Celsius.

### Examples 11-14

### Comparative Example 3

ULTEM type polyetherimide type polyimide coated carbon fiber braid can be obtained by braiding the following carbon fiber. Unsized 12K high tensile strength, standard modulus carbon fiber “Torayca” T700SC (Registered trademark by Toray Industries—strand strength 4.9 GPa, strand modulus 230 GPa) was used. The carbon fiber was continuously submerged in the sizing bath containing polyamic acid dimethylaminoethanol salt of 0.1 to 2.0 weight %. The polyamic acid is formed from the monomers 2,2′-Bis(4-(3,4-dicarboxyphenol)phenyl)propane dianhydride and meta-phenylene diamine. After the submerging process, it was dried at 300 degrees Celsius for 1 minute in order to have ULTEM type polyetherimide coating. The imidization ratio was 98%. The sizing amount was measured with an alkaline method.

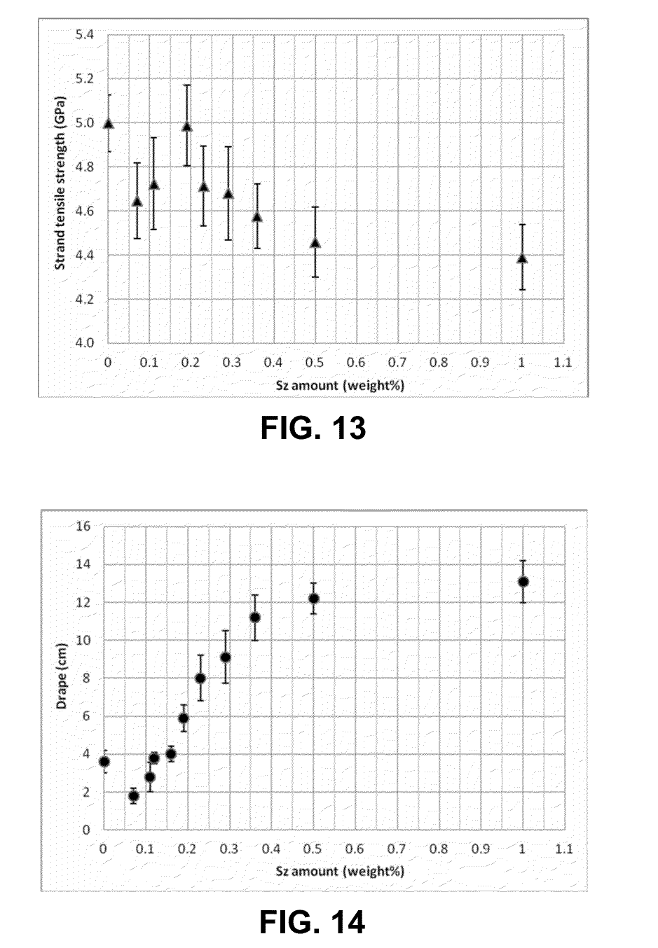

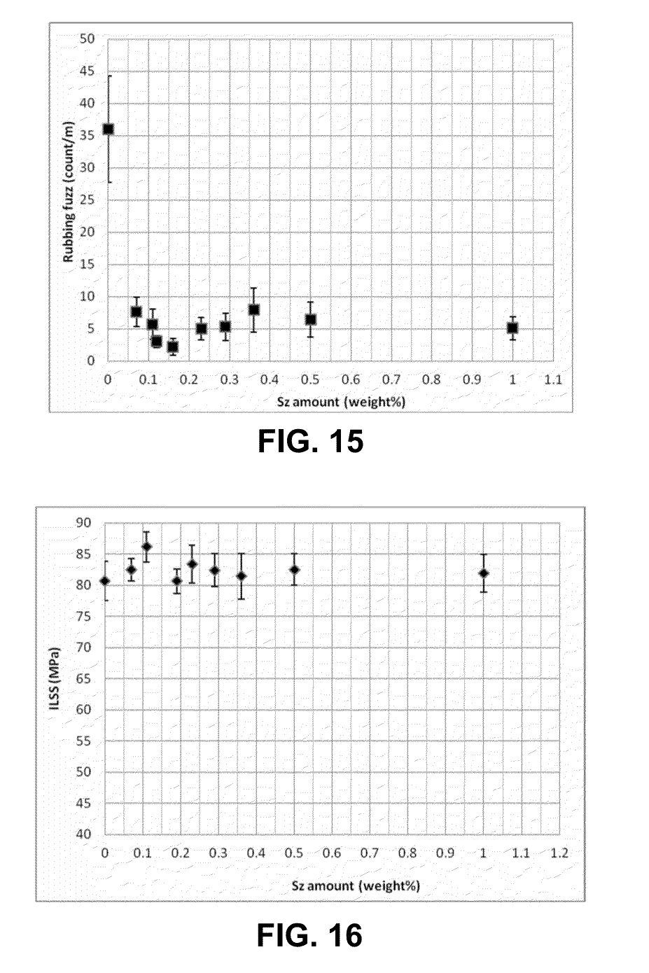

The tensile strengths, drape value, rubbing fuzz and ILSS of both the sizing amount of 0.05 to 1.00 weight % (Examples 11-14) and unsized fiber (Comparative Example 3) were measured. The results are shown in Tables 9-12 and FIGS. 13-16. The error bar in the figures indicates the standard deviation.

### Examples 15-19

### Comparative Example 4

Methylated melamine-formaldehyde coated carbon fiber braid can be obtained by braiding the following carbon fiber.

Unsized 12K high tensile strength, standard modulus carbon fiber “Torayca” T700SC (Registered trademark by Toray Industries—strand strength 4.9 GPa, strand modulus 230 GPa) was used. The carbon fiber was continuously submerged in the sizing bath containing 0.2 to 1.6 weight % of methylated melamine-formaldehyde resin. After the submerging process, it was dried at 220 degrees Celsius for 1 minute. The sizing amount was measured with a burn off method.

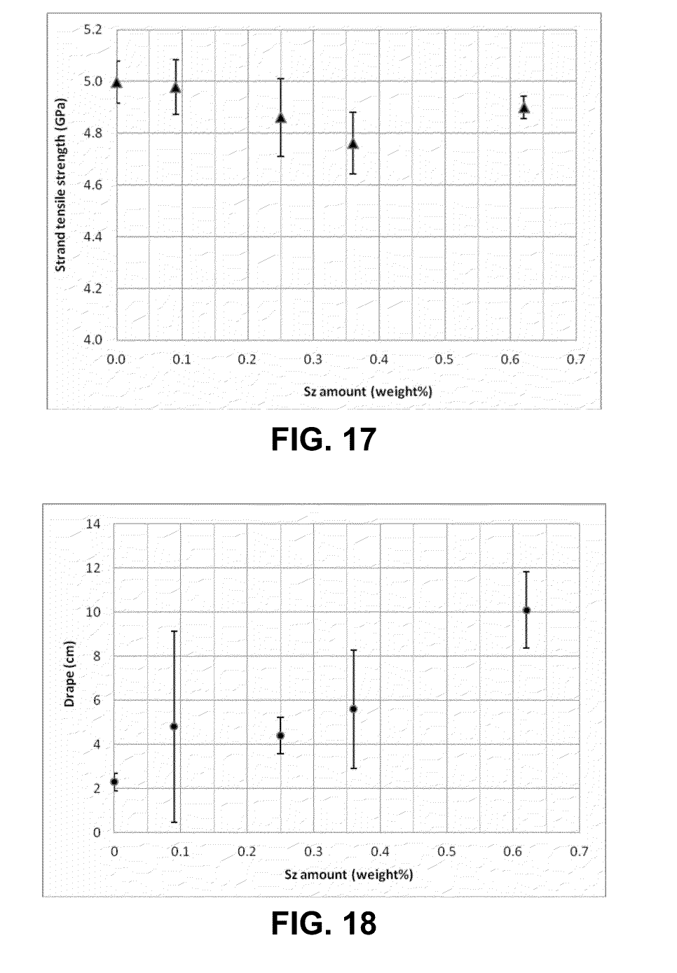

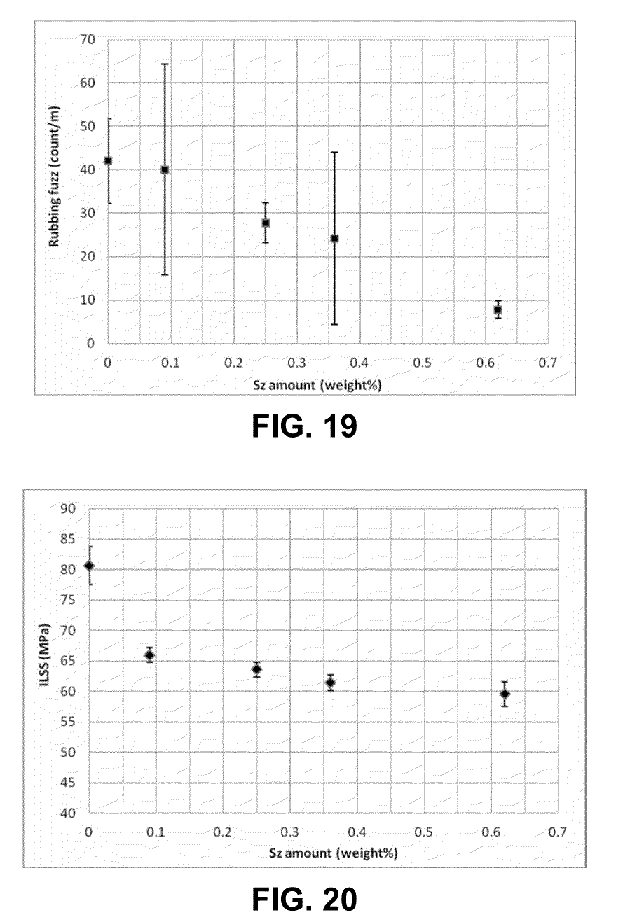

The tensile strengths, drape value, rubbing fuzz and ILSS of both the sizing amount of 0.05 to 0.62 weight % (Examples 15-18) and unsized fiber (Comparative Example 4) were measured. The results are shown in Tables 13-16 and FIGS. 17-20. The error bar in the figures indicates the standard deviation.

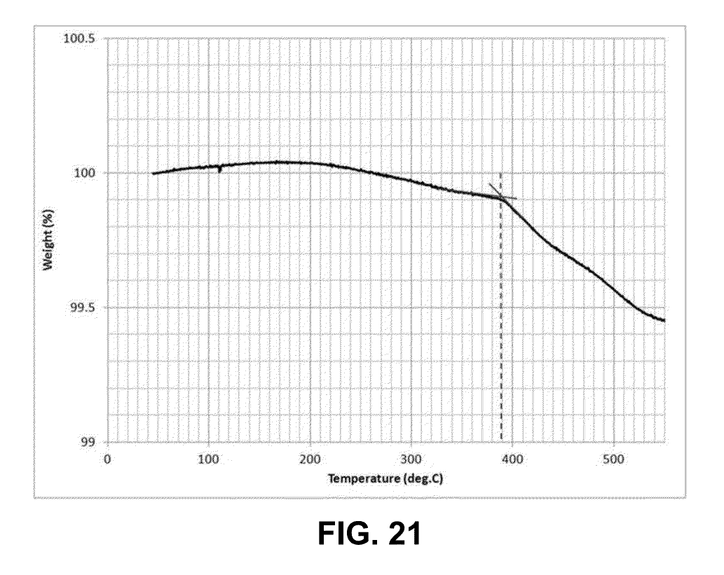

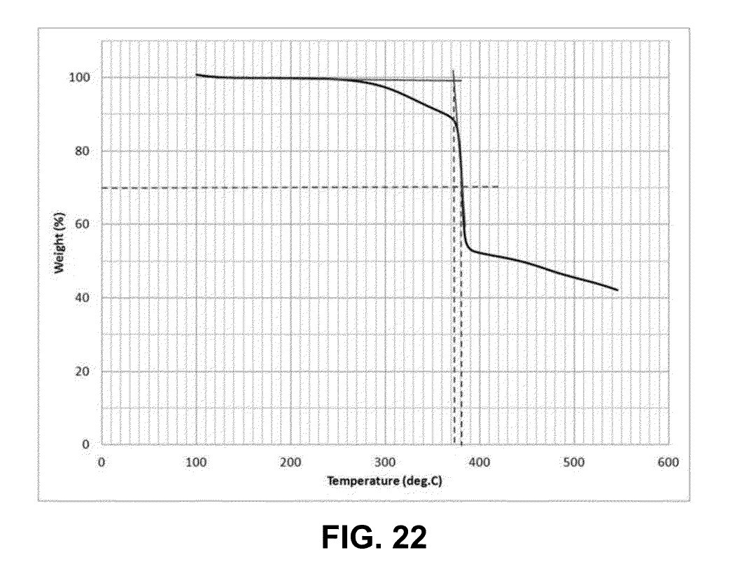

Thermogravimetric analysis (TGA) was conducted under air atmosphere. (Example 19) The heat degradation onset temperature of the same carbon fiber as the above is 390 degrees Celsius as shown in FIG. 21. The heat degradation onset temperature of the sizing is 375 degrees Celsius and the 30% weight reduction temperature is 380 degrees Celsius as shown in FIG. 22, confirming the heat resistance is in excess of 350 degrees Celsius.

### Examples 20-24

### Comparative Example 5

Epoxy cresol novolac coated carbon fiber braid can be obtained by braiding the following carbon fiber. Unsized 12K high tensile strength, standard modulus carbon fiber “Torayca” T700SC (Registered trademark by Toray Industries—strand strength 4.9 GPa, strand modulus 230 GPa) was used. The carbon fiber was continuously submerged in the sizing bath containing 0.1 to 2.0 weight % of epoxy cresol novolac resin. After the submerging process, it was dried at 220 degrees Celsius for 1 minute. The sizing amount was measured with a burn off method.

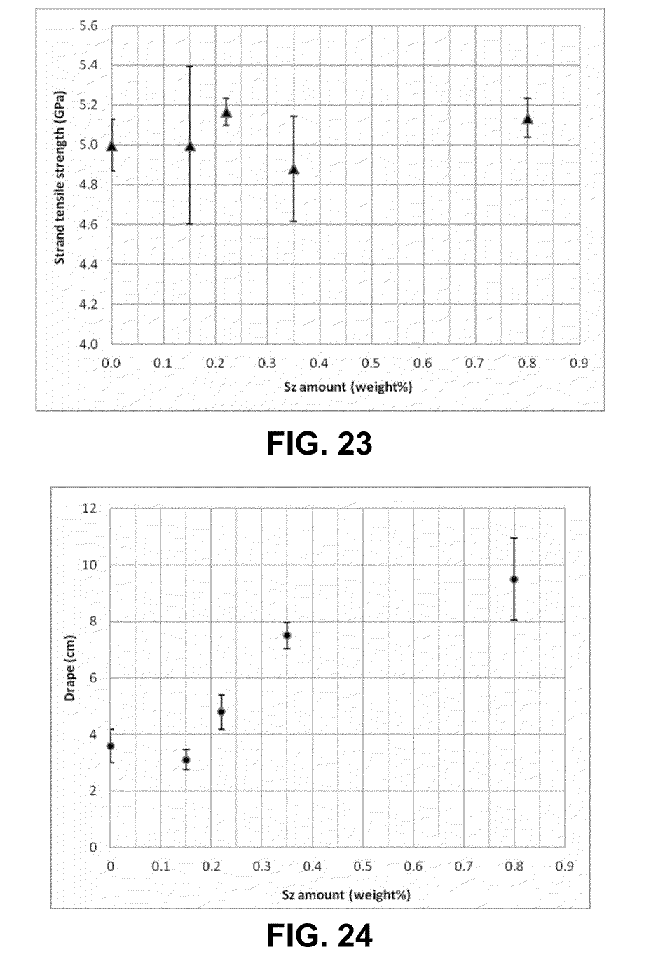

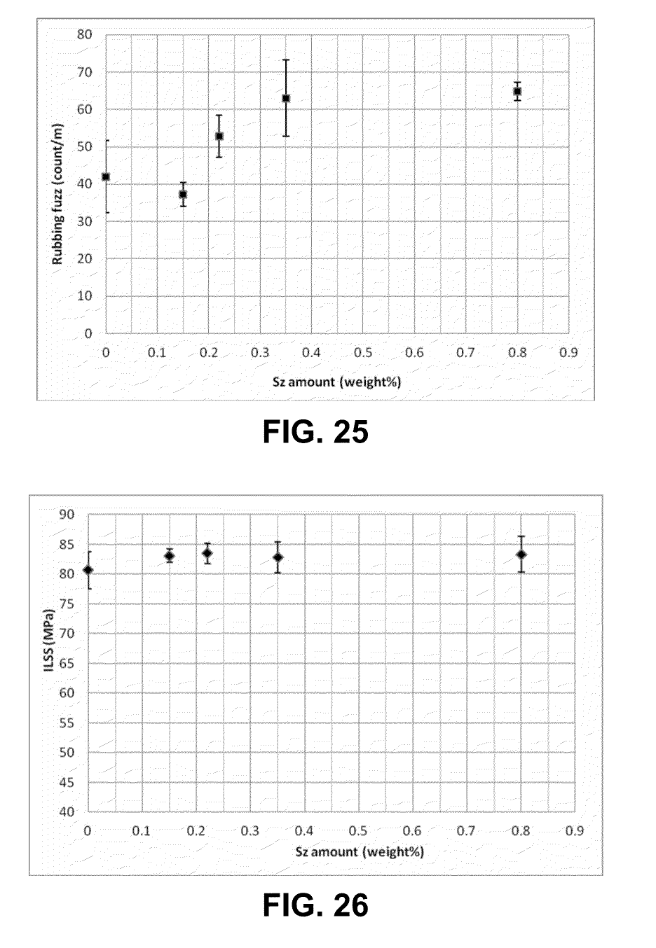

The tensile strengths, drape value, rubbing fuzz and ILSS of both the sizing amount of 0.05 to 0.80 weight % (Examples 20-23) and unsized fiber (Comparative Example 5) were measured. The results are shown in Tables 17-20 and FIGS. 23-26. The error bar in the figures indicates the standard deviation.

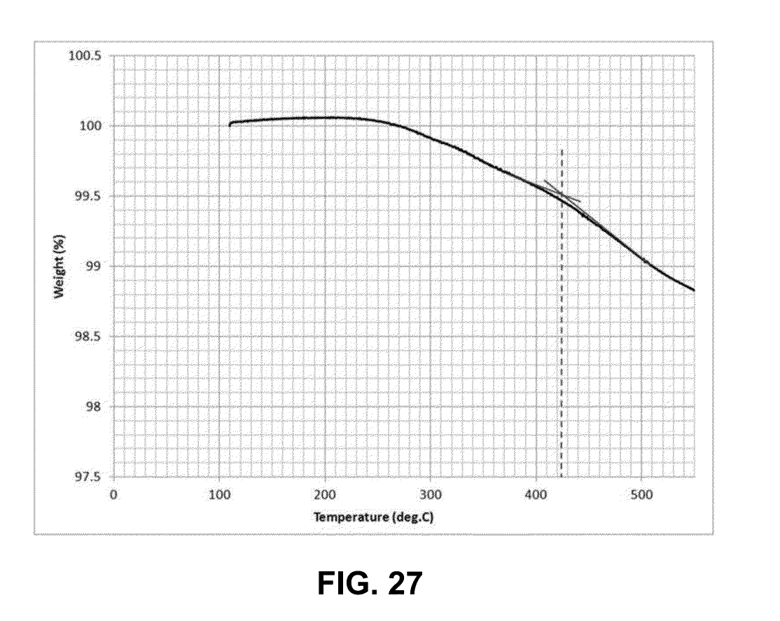

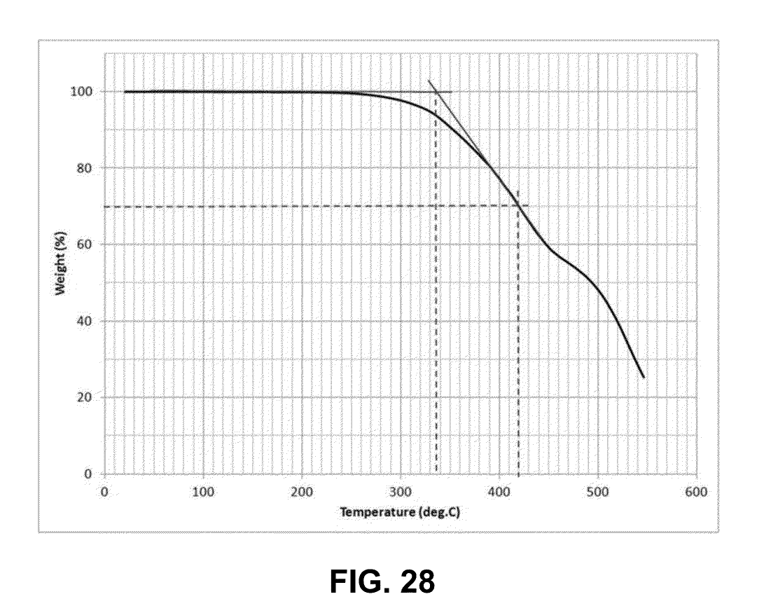

Thermogravimetric analysis (TGA) was conducted under air atmosphere. (Example 24) The heat degradation onset temperature of the same carbon fiber as the above is 423 degrees Celsius as shown in FIG. 27. The heat degradation onset temperature of the sizing is 335 degrees Celsius and the 30% weight reduction temperature is 420 degrees Celsius as shown in FIG. 28, confirming the heat resistance is in excess of 300 degrees Celsius.

### Examples 25, 26

### Comparative Example 6

As indicated in Examples 1 and 6, the carbon fiber with about 0.2 weight % heat resistant sizing (Examples 25, 26), and Unsized fiber T800SC-24K (Comparative Example 6) were used.

FIG. 29 and Table 21 show the results of SFFT using polyetherimide resin. From the results, it can be shown the IFSS of Examples 25 and 26 are over 5% higher than that of Comparative Example 6.

### Examples 27, 28, 29

### Comparative Example 7

As indicated in Examples 11, 15 and 20, the carbon fiber with about 0.2 weight % heat resistant sizing (Examples 27, 28, 29) and Unsized fiber T700SC-12K (Comparative Example 7) were used.

FIG. 30 and Table 22 show the results of SFFT using polyetherimide resin. It can be shown the IFSS of Examples 27 through 29 are over 5% higher than that of Example 22 and the IFSS of Examples 27 and 29 are over 10% higher than that of Comparative Example 7.

While the invention has been explained with reference to the specific embodiments of the invention, the explanation is illustrative and the invention is limited only by the appended claims.

What is claimed is:

1. A carbon fiber braid formed of a carbon fiber coated with a sizing, said sizing being formed of a heat resistant polymer or a precursor of the heat resistant polymer.

2. The carbon fiber braid according to claim 1, wherein said heat resistant polymer is applied on the carbon fiber in a form of at least one of an aqueous solution, an aqueous dispersion or an aqueous emulsion.

3. The carbon fiber braid according to claim 1, wherein said heat resistant polymer is formed of at least one of a phenol resin, a melamine resin, a urea resin, a polyimide resin, a polyetherimide resin, a polysulfone resin, a polyethersulfone resin, a polyetheretherketone resin, a polyetherketoneketone resin, a polyamide resin, and a polyphenylenesulfide resin.

4. The carbon fiber braid according to claim 1, wherein said carbon fiber is produced in a continuous process including carbonization, surface treatment, sizing application and winding.

5. The carbon fiber braid according to claim 1, wherein said heat resistant polymer has a thermal degradation onset temperature higher than 300 degrees Celsius.

6. The carbon fiber braid according to claim 1, wherein said heat resistant polymer has a 30% weight reduction temperature higher than 350 degrees Celsius.

7. The carbon fiber braid according to claim 1, wherein said carbon fiber has an interfacial shear strength A greater than an interfacial shear strength B of a carbon fiber without the sizing to satisfy a relation of A>B, said interfacial shear strength A and B being measured with a single fiber fragmentation test.

8. The carbon fiber braid according to claim 1, wherein said carbon fiber is produced through a fabrication process including a drying process at a temperature higher 200 degrees Celsius for longer than 6 seconds.
